(19) United States
(12) Patent Application Publication
(10) Pub. No.: US 2011/0101712 A1
(43) Pub. Date: May 5, 2011

(54) DAMPENED BAYONET LATCH

(75) Inventor: Richard J. LaConte, Black Diamond, WA (US)

(73) Assignee: Harper Engineering Co., Renton, WA (US)

(21) Appl. No.: 12/612,146

(22) Filed: Nov. 4, 2009

(51) Int. Cl. E05C 19/04

(52) U.S. Cl. 292/252; 292/300; 292/302

(57) ABSTRACT

A latch mechanism is described allowing controlled access to the area secured by the latch mechanism, wherein the latch element is captured and released by the latch mechanism only upon slow, steady pressure overriding a dampening element. Sudden movement of the latch element is resisted in relationship to the force applied.

### TECHNICAL FIELD

The present invention relates to latching mechanisms, and more particularly, to a hidden dampened latch mechanism allowing limited access to the area behind the latched panel; and still more particularly, to a latch hidden from view wherein a dampener is operatively connected to a selectively latched ball or other thrust mechanism, hereinafter bayonet, which prevents sudden sharp movement from unlatching the device, whereas a slow, steady pressure will overcome the dampening and allow the latch to unlatch, thereby permitting removal of or access behind the latched panel.

### BACKGROUND OF THE INVENTION

It is known to have adjustable pressure or blow-off latches for use on the exterior of an airplane, as taught by U.S. Pat. No. 5,765,883 granted to Thessinberger et al, Jun. 16, 1998; U.S. Pat. No. 6,513,841 granted to Jackson, Feb. 4, 2003; and U.S. Pat. No. 6,755,448 granted to Jackson et al, Jun. 29, 2004.

Interior aircraft panels and load-regulating latches are also known, as taught by U.S. Pat. No. 4,739,955 granted to Aquino, Apr. 26, 1988; U.S. Pat. No. 4,445,463 granted to Fletcher et al, Aug. 30, 1977; and U.S. Pat. No. 6,866,226 granted to Pratt et al, Mar. 15, 2005. It is assumed that each of these latches operate in the manner described, primarily to release the panel upon a predetermined change in pressure or to adjust loads on the structure in response to a change in pressure caused by a rapid directional change or the like.

### BRIEF DESCRIPTION OF THE DRAWINGS

FIG. 1 is an isometric view of a possible environment showing one possible location for the inventive latch.

FIG. 2 is a perspective view of the inventive latch.

FIG. 3 is an elevational view of the inventive latch.

FIG. 4 is a sectional view of the inventive latch in the unlatched position.

FIG. 5 is a sectional view of the inventive latch being moved to release the bayonet.

FIG. 6 is an elevational view of the inventive latch, wherein the bayonet has been fully released.

FIG. 7 is an elevational view of the inventive latch, with the latch members returned to their at rest position.

FIG. 8 is an elevational view showing the bayonet released.

FIG. 9 is an elevational view with the latch members in the at rest position.

FIG. 10 is an exploded view of another embodiment of a bayonet latch.

FIG. 11 is an elevational view of the bayonet latch being latched.

FIG. 12 is an elevational view in the latched position.

FIG. 13 is an elevational view depicting the unlatching with a slow and steady pressure.

FIG. 14 is an elevational view in the unlatched position.

FIG. 15 is an elevational view illustrating the reaction to a rapid release attempt.

### BEST MODE FOR CARRYING OUT THE INVENTION

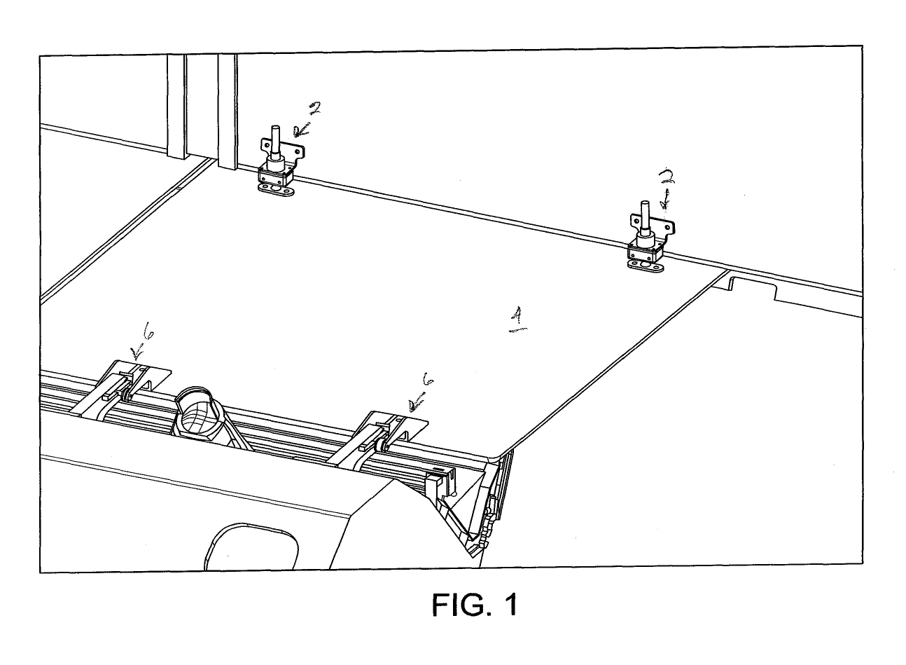

As seen in FIG. 1, one of the environments wherein the present invention is found to be useful is in securing the ceiling panels in place in an airplane. As seen in this view, the inventive dampened release fastener, as explained in detail hereinafter, is depicted at 2 adhered to a ceiling panel 4 which is secured at the opposite edge by dampened release fasteners 6, as described in co-pending application Ser. No. 11/955,762. As will be obvious, the ceiling panels 4 are in place to give the airplane a finished look, but also to secure operational features of the airplane secured from the passengers which may need to be serviced. Thereby, the fastening means, while resisting sudden movement such as being bumped by a passenger's luggage or the like, allows the panel 4 to be released or removed with the use of steadily applied low pressure.

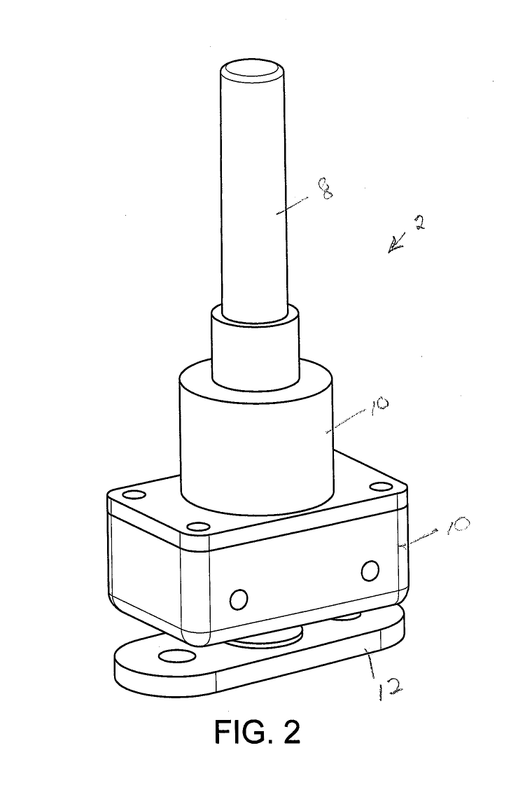

Reference is now had to FIG. 2, which is an isometric view of the bayonet latch. As seen in this view, the linear damper 8 extends out of housing 10 which, as explained hereinafter, contains the latch mechanism; base 12 of the bayonet latch is shown as well.

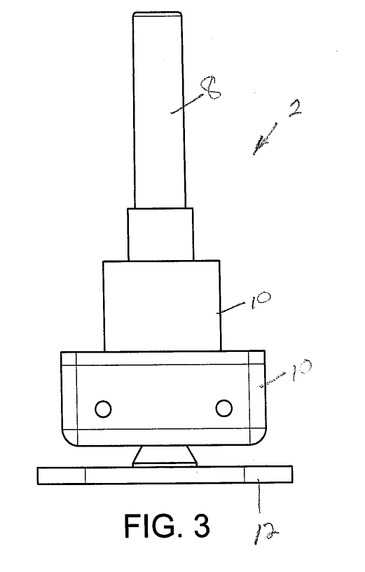

FIG. 3 is an elevational view of the latch of FIG. 2 and shows the elements having identical numerals as FIG. 2.

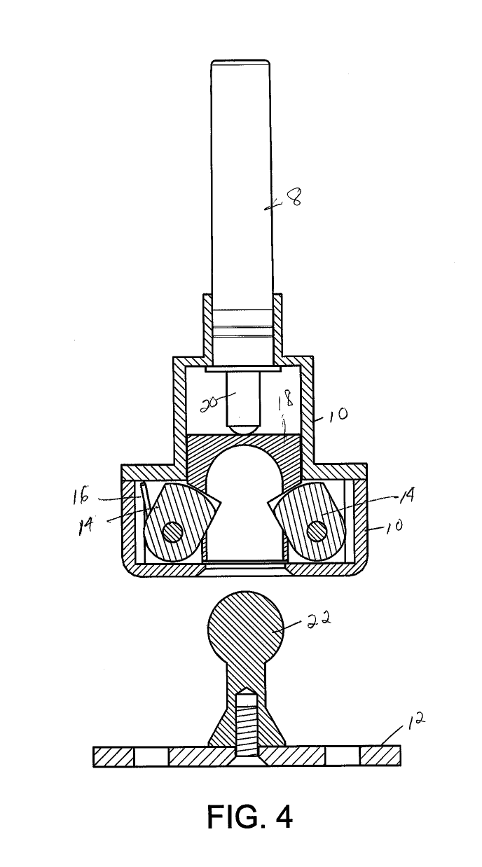

FIG. 4 is a sectional view of the latch of FIGS. 2 and 3 showing the catches 14 which are spring-biased in their inward position by springs (only one of which is shown). As explained hereinafter, actuator 18, the position of which is controlled by a push rod 20 of the dampening mechanism 8, as will be explained hereinafter, as the actuator 18 moves along a linear path, moves the catch 14 to the open position or alternatively lets it return to the latched position. As seen in this view, the ball member of bayonet 22 is in the released position.

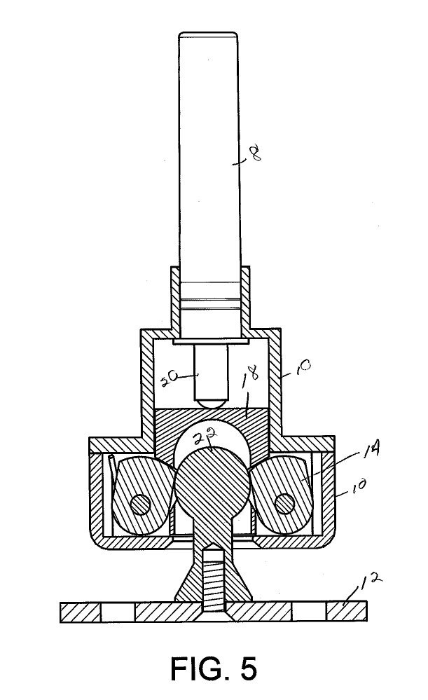

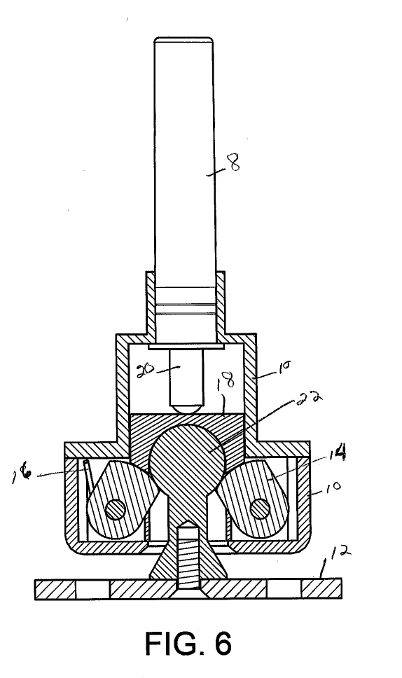

FIG. 5 depicts the latch during the latching process and the bayonet 22 moving upwardly in this drawing, which pushes the catch 14 outwardly in the dampener 20 retains the actuator 18 at its lowermost position. Reference is now had to FIG. 6, wherein the ball or bayonet 22 is in the fully latched stored locked position, catches 14 have been forced inwardly by springs 16 and the actuator 18 is in its lowermost position.

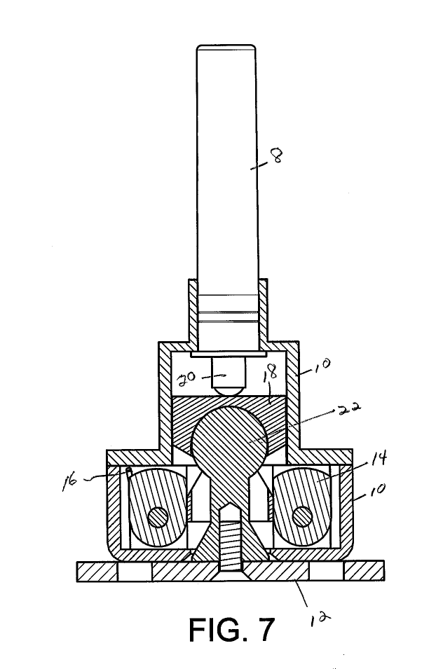

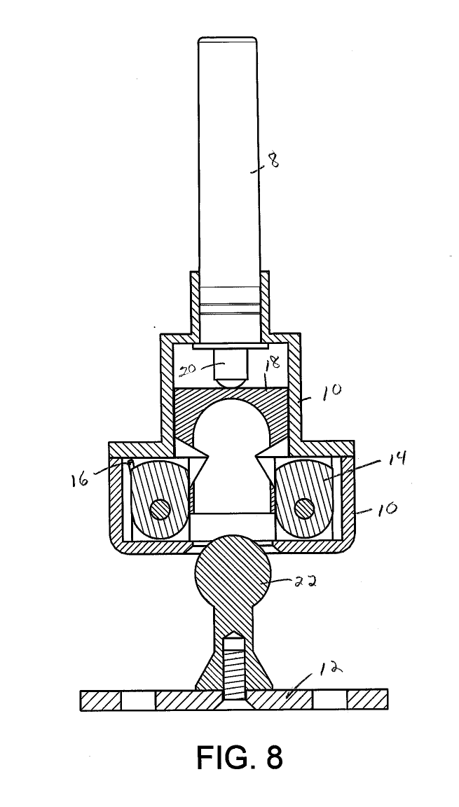

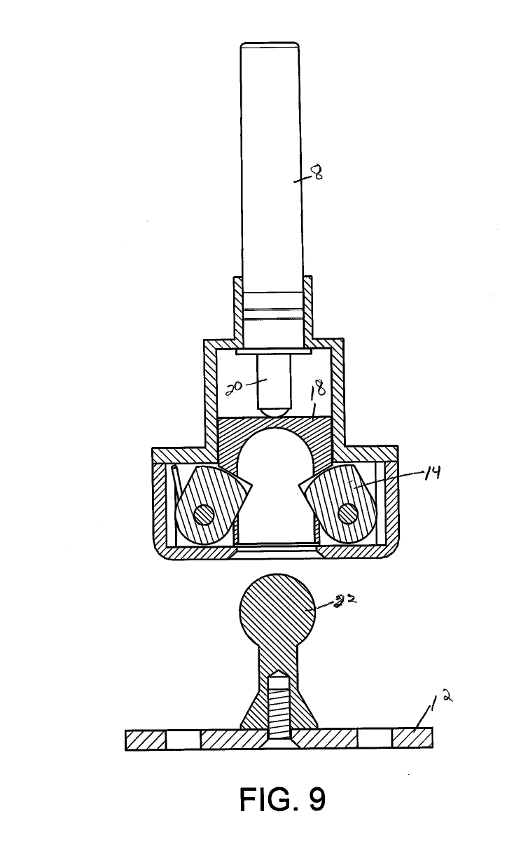

Reference is now had to FIG. 7, wherein the latch is in the process of being unlatched. The base unit 12 with its attached ball or bayonet 22 has been moved upwardly, using a slow, steady pressure, causing actuator 18 to likewise move upwardly, requiring the shaft 20 of the dampener 8 to retract within the body of the dampener and the lower shoulders of the actuator 24 have moved upwardly, forcing the catches 14 outwardly against the spring resistance of springs 16. At this point, the ball or bayonet 22 may be removed and, as seen in FIGS. 8 and 9, once the dampener 8 has pushed the actuator 18 downwardly, allows the catches to resume their normal position.

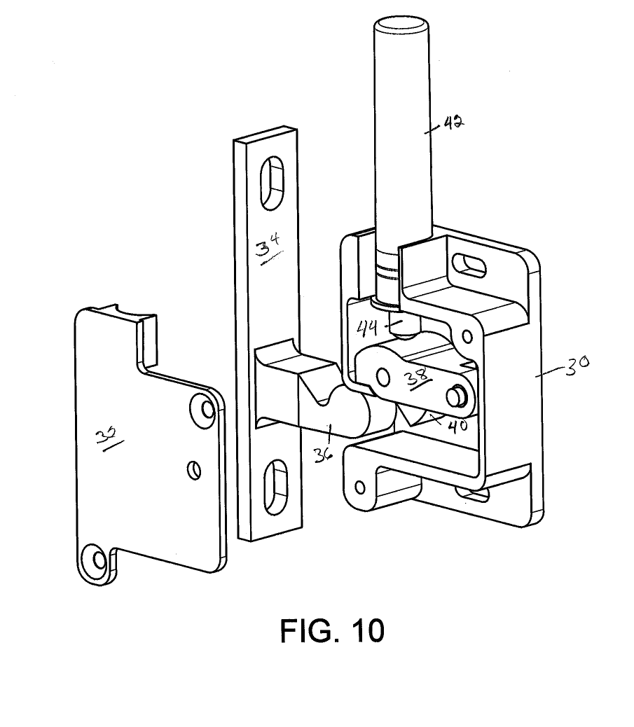

Reference is now had to FIG. 10, wherein an ultimate configuration of a dampened latch is shown, including a body 30, body cover 32, face plate 34 including an outwardly extending bayonet or configured latch member 36. Mounted internally of the body 30 is an actuator 38 and a catch 40, pivotally mounted to the pivotally mounted actuator 38. In this embodiment, mounted to the body above the actuator is the dampener 42 having a push rod 44.

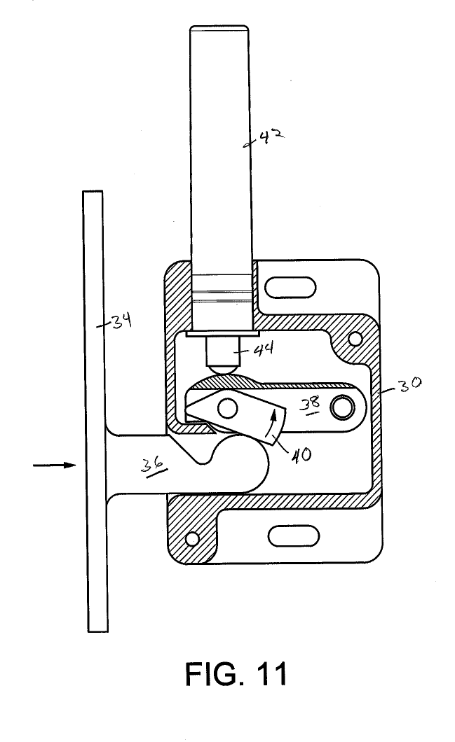

Reference is now had to FIG. 11, wherein the face plate and bayonet member 36 are being moved into a latched position, pivoting catch 40 about its pivot point.

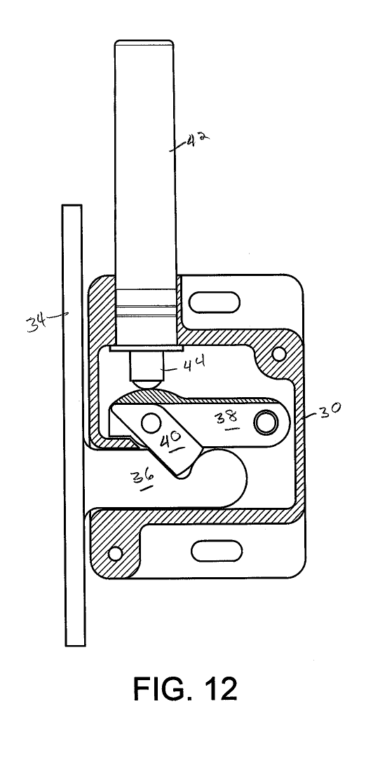

As seen in FIG. 12, the device is latched, wherein catch member 40 fully engages the bayonet 36.

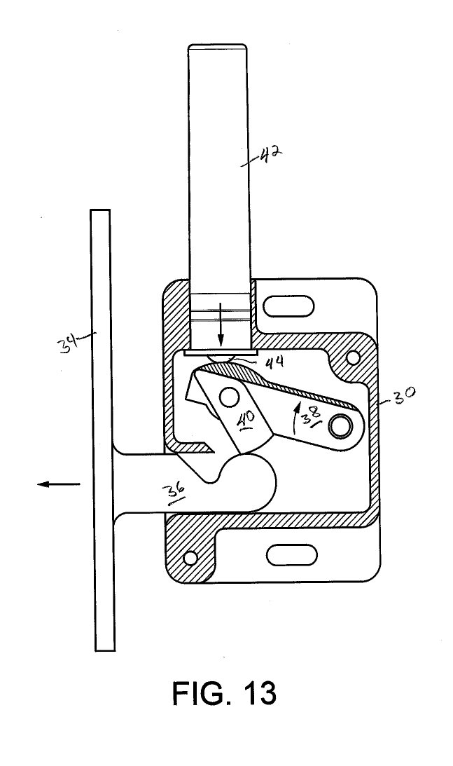

FIG. 13 depicts the latch as being released. A slow, steady force has been applied to the panel supporting the face plate 34, causing the bayonet 36 to force the catch member 40 and the attached actuator 38 upwardly, forcing the push rod 44 into the dampener, allowing the catch to be released.

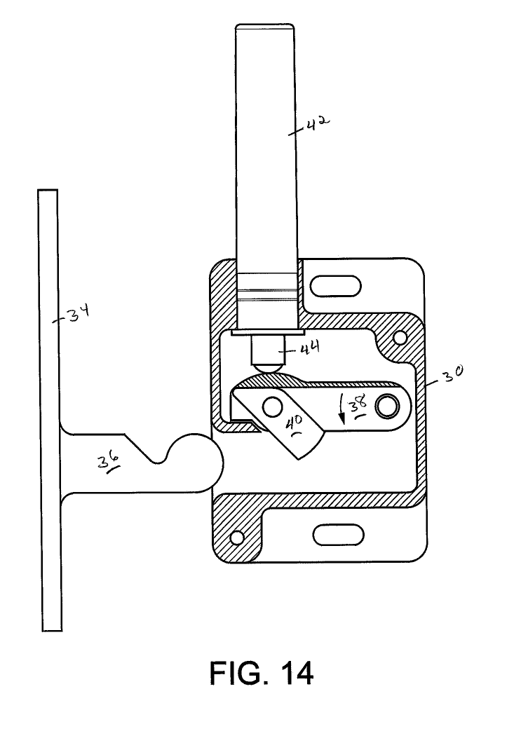

As seen in FIG. 14, the latch is completely released from the catch member 40 and the actuator 38 is pivoted downwardly to its normal at-rest position.

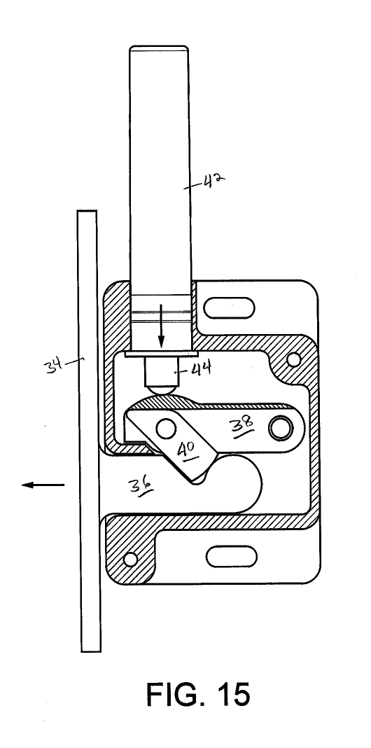

FIG. 15 depicts what happens when a rapid sudden force is applied to the face plate 34, jamming the catch 40 and actuator 38 against the push bar 44, which is strongly resisted by the dampener 42. In fact, the resistance to removal is directly related to the amount of force applied. In other words, the stronger the force, the stronger the resistance.

Thus as can be seen, the present invention allows selected access behind the panel or doors secured by the latch, but prevents entry by persons not familiar with the characteristics of the latch, and further prevents inadvertent opening because of jostling or the like.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. A dampened bayonet latch allowing controlled access to the space secured by the latch, comprising:
a housing to be secured to a relatively fixed object, including an actuator having limited axial movement;
catches which, in conjunction with a damper, control the movement of the actuator; and
a bayonet element to be secured to a selectively removable element, including an outwardly projecting ball to mate with the actuator and be restrained in the mated position by said latches, whereby slow movement of the bayonet and actuator overcomes the damper and releases the catches.

2. A latch for selectively securing a panel in place, comprising:
a first element secured to a panel to be secured;
a second element secured to a relatively fixed object to which the panel is to be secured; and
intermediate catch means to selectively secure the first and second elements, said latch means including dampening means preventing unlatch in response to rapid movement, yet allowing unlatch as a result of slow, steady movement.

3. A latch assembly, comprising:
a housing unit to be secured to a relatively fixed object, said housing unit comprising an exterior shell, a pair of opposing catch units pivotably mounted inside the shell, said latch units being biased toward each other;
an opening in the shell adjacent to and between said catch units and a dampening unit secured to said shell opposing the opening;
an actuator mounted for linear movement within said shell, between and interactive with said catch units and dampening unit; and
a latch element to be secured to a relatively movable object, said latch element comprising a base and an outwardly projecting bulbous element to be inserted through the opening in the shell and interacting with the actuator, catch means and dampening unit, such that the latch is unlatched only by steady pressure against the dampening unit.

4. A selective release latch to prevent inadvertent release, comprising:
a latch body including an actuator whose movement is restricted by a damper and catch means having limited pivotal movement controlled by said actuator; and
bayonet means selectively captured by said catch means for linear movement into and out of said latch body, whereby slow, steady movement of the bayonet moves the actuator, releasing the latch means and the bayonet.

5. A latch means as in claim 4, wherein the release movement of the bayonet is toward the body.

6. A latch as in claim 4, wherein the release movement of the bayonet is away from the body.

7. A latch as in claim 4, wherein the latch means is pivotably mounted to said actuator.

8. A latch as in claim 4, wherein the latch means is pivoted as a result of the movement of the actuator.

9. A selective release latch mechanism, comprising:
a first element secured to a relatively fixed object;
a second element secured to a selectively removable object; and
a dampening element secured to either the first or second element and interactive with catch means, said catch means securing said first and second elements in a latched condition and wherein said first and second elements can only be unlatched by the slow and steady pressure overriding the dampening force.
